(19) United States
(12) Patent Application Publication
(10) Pub. No.: US 2022/0134790 A1
(43) Pub. Date: May 5, 2022

(54) METHOD OF TEMPLATE MANUFACTURING FOR PAPER DIE-CREASING AND FOLDING APPLICATION

(71) Applicant: GREAT COMPUTER CORP., New Taipei City (TW)

(72) Inventors: Liang SHIH, New Taipei City (TW); Chen-Chien TSAI, New Taipei City (TW)

(21) Appl. No.: 17/242,546

(22) Filed: Apr. 28, 2021

(30) Foreign Application Priority Data
Nov. 2, 2020 (TW) 109138105

(51) Int. Cl. B41M 5/00; B31B 50/00; B31B 50/26; B41M 7/00

(52) U.S. Cl. CPC B41M 5/0088; B41M 7/0081; B31B 50/26; B31B 50/006

(57) ABSTRACT

A method of template manufacturing for paper die-creasing and folding application is disclosed; first of all, an image file having die-creases is output to a UV inkjet printer first, and a template is disposed in the UV inkjet printer to allow the UV inkjet printer to print the image file on the template, thereby forming the image file having die-creases on the template; then the template with the image file having die-creases thereon is assembled onto a roller of a die-creasing machine to carry out a die-creasing process for paper materials.

### FIELD OF THE INVENTION

The present invention relates to a method of template manufacturing for paper die-creasing and folding application, which can attain the objective of low-cost and rapid customization by manufacturing templates for paper die-creasing in a manner of digital printing, and is particularly applicable to folding and shaping processings for existing paper materials.

### BACKGROUND OF THE INVENTION

Generally, in order to facilitate the folding and shaping processing of paper materials, indentation lines are first generated at the position to be bent to facilitate subsequent folding. There are many ways to generate the indentation lines. If the indentation line is a single straight line passing through the paper materials, it is usually produced by using an indentation forming roller. If the required indentation line is a complicated curve or line segment, it is usually accomplished by using an indentation template or an indentation line ruling machine, wherein the indentation template belongs to a mass production application, and the indentation line ruling machine belongs to a small scale proofing production.

Conventional manufacturing methods for typical indentation templates include CNC machining, electrical discharge machining, and the manual assembling of indentation cutting die on a wooden board. However, the above-mentioned conventional manufacturing processes have disadvantages such as a high-cost and time-consuming template production, which are not ideal.

### SUMMARY OF THE INVENTION

Therefore, to provide a method different from the prior art, the Inventors provide the present invention on the basis of years of experience and persistent development and improvement.

A main objective of the present invention is to provide a low-cost and rapidly-customized method of template manufacturing for paper die-creasing and folding application.

To achieve the abovementioned objectives, the method of template manufacturing for paper die-creasing and folding application of the present invention comprises the steps of:

step (a): outputting an image file having die-creases to a UV inkjet printer:

step (b): disposing a template in the UV inkjet printer to allow the UV inkjet printer to print the image file on the template, thereby forming the image file having die-creases on the template;

step (c): assembling the template with the image file having die-creases thereon onto a roller of a die-creasing machine to carry out a die-creasing process for paper materials.

In implementation, the die-creases of the image file in the step (a) is formed via an ink bleeding on a basis of a required depth of the die-creases, or a property or a thickness of the paper materials to be processed, and wherein the UV inkjet printer in the step (b) adjusts a number of times for discharging inks based on the depth of the die-creases, so as to allow the die-creases to protrude from the template, and make the template a male mold.

In implementation, the image file having die-creases in the step (a) is formed by mirroring the image file and inverting the mirrored image file, and then choking the die-creases of the image file on a basis of a required depth of the die-creases, or a property or a thickness of the paper materials to be processed, and wherein the UV inkjet printer in the step (b) repeatedly discharges inks onto areas apart from the die-creases on the template based on a position of the die-creases, so as to allow the die-creases to present a recession on the template, and make the template a female mold.

In implementation, the male mold and the female mold are assembled onto rollers of a die-creasing machine respectively, so as to carny out a die-creasing process for paper materials.

Other objects, advantages and novel features of the present invention will become more apparent from the following detailed description when taken in conjunction with the accompanying drawings.

### BRIEF DESCRIPTION OF THE DRAWINGS

FIG. 1 is a flowchart showing an embodiment of the present invention.

FIG. 2 is a perspective view of the male mold of the embodiment of FIG. 1.

FIG. 3 is a perspective view of the female mold of the embodiment of FIG. 1.

### DETAILED DESCRIPTION

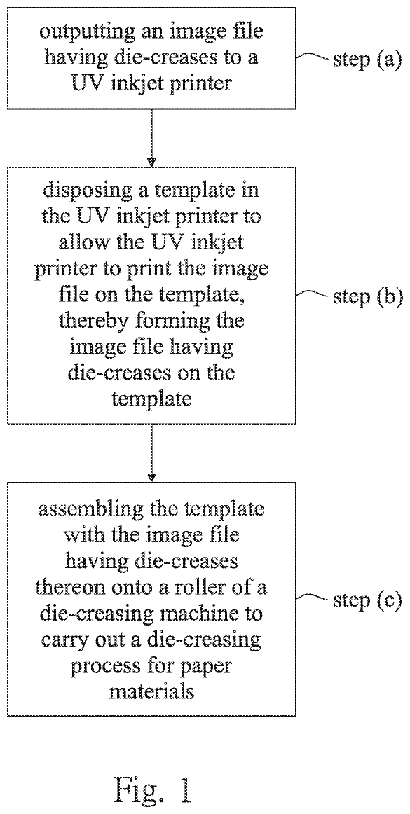

Referring to FIG. 1, a flowchart showing a method of template manufacturing for paper die-creasing and folding application of the present invention is disclosed, which comprises the following steps:

step (a): outputting an image file having die-creases to a UV inkjet printer;

step (b): disposing a template in the UV inkjet printer to allow the UV inkjet printer to print the image file on the template, thereby forming the image file having die-creases on the template:

step (c): assembling the template with the image file having die-creases thereon onto a roller of a die-creasing machine to carry out a die-creasing process for paper materials.

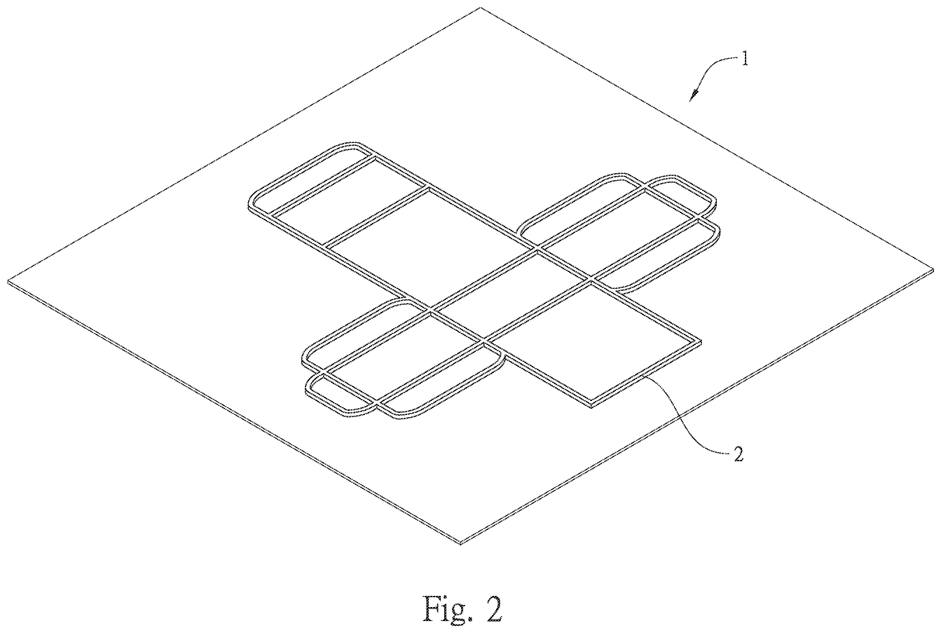

Therefore, when this embodiment is implemented, the die-creases of the image file in the step (a) is formed via an ink bleeding on a basis of a required depth of the die-creases, or a property or a thickness of the paper materials to be processed, and wherein the UV inkjet printer in the step (b) adjusts a number of times for discharging inks based on the depth of the die-creases, so as to allow the die-creases to protrude from the template, and make the template a male mold 1 (as shown in FIG. 2). The male mold 1 is eventually assembled onto a roller of a die-creasing machine, so as to carry out a die-creasing process for paper materials by the die-creases 2 formed on the male mold 1 (i.e., step (c)).

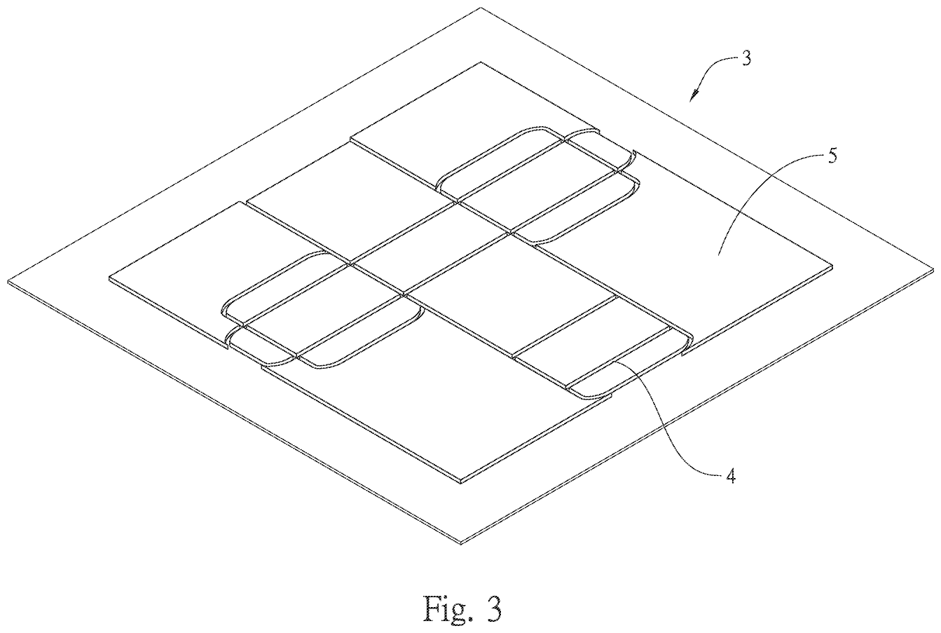

If a female mold is used as the template having die-creases, the image file having die-creases in the step (a) would be formed by mirroring the image file and inverting the mirrored image file, and then choking the die-creases of the image file on a basis of a required depth of the die-creases, or a property or a thickness of the paper materials to be processed, and wherein the UV inkjet printer in the step (b) repeatedly discharges inks onto areas apart from the die-creases on the template based on a position of the die-creases, so as to allow the die-creases to present a recession on the template, and make the template a female mold 3 (as shown in FIG. 3). The female mold 3 is eventually assembled onto a roller of a die-creasing machine, so as to carry out the die-creasing process for paper materials by the projection areas 5 surrounding the die-creases 4 formed on the female mold 3 (i.e., step (c)).

Further, the male mold 1 and the female mold 3 certainly could be simultaneously assembled onto two rollers of a die-creasing machine respectively, so as to carry out the die-creasing process for paper materials.

Therefore, through the above-mentioned design for the template, the present invention directly forms an image having die-creases on the template by printing the image file on the template via the UV inkjet printer. Accordingly, in the respect of using complicated patterns or segments, the working hours for manufacturing the template and the cost of the template could be efficiently reduced, thereby attain the objective of rapid customization.

The exemplary embodiments have been illustrated: however, the method of performing foil sleeking after printing for UV inkjet printer according to the present invention is not limited thereto. According to modifications or combinations of the embodiments, various types of methods of performing foil sleeking after printing for UV inkjet printer can be realized having the scope of the present invention and thus without departing from the technical spirit of the present invention.

As disclosed above, the present invention indeed achieves the objectives of the present invention by providing a method of template manufacturing for paper die-creasing and folding application. The present invention has significant values in terms of industrial applications, and a patent application is thus filed in accordance with the law.

1. A method of template manufacturing for paper die-creasing and folding application, comprising steps of:
step (a): outputting an image file having die-creases to a UV inkjet printer;
step (b): disposing a template in the UV inkjet printer to allow the UV inkjet printer to print the image file on the template, thereby forming the image file having die-creases on the template;
step (c): assembling the template with the image file having die-creases thereon onto a roller of a die-creasing machine to carry out a die-creasing process for paper materials.

2. The method of claim 1, wherein the die-creases of the image file in the step (a) is formed via an ink bleeding on a basis of a required depth of the die-creases, or a property or a thickness of the paper materials to be processed, and wherein the UV inkjet printer in the step (b) adjusts a number of times for discharging inks based on the depth of the die-creases, so as to allow the die-creases to protrude from the template, and make the template a male mold.

3. The method of claim 1, wherein the image file having die-creases in the step (a) is formed by mirroring the image file and inverting the mirrored image file, and then choking the die-creases of the image file on a basis of a required depth of the die-creases, or a property or a thickness of the paper materials to be processed, and wherein the UV inkjet printer in the step (b) repeatedly discharges inks onto areas apart from the die-creases on the template based on a position of the die-creases, so as to allow the die-creases to present a recession on the template, and make the template a female mold.
